(19) United States
(12) Patent Application Publication
(10) Pub. No.: US 2009/0238636 A1
(43) Pub. Date: Sep. 24, 2009

(54) Tie rod end with a ball joint

(76) Inventors: Chas Howe, Beaverton, MI (US); Kelly Molenaar, Kalamazoo, MI (US)

Correspondence Address: MCKELLAR IP LAW, PLLC, 784 SOUTH POSEYVILLE ROAD, MIDLAND, MI, 48640, US

(21) Appl. No.: 12/383,042

(22) Filed: Mar. 19, 2009

Related U.S. Application Data
(60) Provisional application No. 61/069,908, filed on Mar. 19, 2008.

(51) Int. Cl. F16D 1/12

(52) U.S. Cl. 403/127

(57) ABSTRACT

This novel ball joint has the advantage that the housing top can be removed for quick and easy replacement of a ball. It also has a grease zerk for easy maintenance. The removal of the cap is also convenient not only for the replacement of the ball but for inspection of the joint for wear or the amount of lubrication present within the housing. It also has the added feature of the snap compression ring to ensure the integrity of the part.

This application claims priority from U.S. Provisional Patent Application No. 61/069,908 filed Mar. 19, 2008.

The present invention deals with a device that is capable of housing a ball joint that allows the ball joint to be quickly inspected, lubricated and replaced.

### BACKGROUND OF INVENTION

The use of ball joints and systems employing them for use in the front wheel suspensions of automobiles is well known in the art. The ball joint provides flexibility in steering. The majority of the ball joints in existence are closed units that are press fit together with grease placed within the housing before they are pressed together. The instant invention allows for quick and easy replacement of a ball joint by removal of the top or cap. This feature also allows the user the ability to inspect the ball joint for wear or to check the level of lubrication present within the housing. The grease zerk also allows the user to lubricate the ball joint without inspection when the need arises.

### THE INVENTION

A ball joint comprising in combination; a ball, the ball having an elongated stem, this ball being movably housed in a ball housing, the housing has an internal surface that is partially threaded. The ball is surmounted by a housing cap wherein the housing cap has an externally threaded surface. The threads are capable of mating with and joining the threads of the housing. The housing cap has surmounted thereon, a nut fixture. This nut fixture has a centered opening therein and contained in this opening is a grease zerk. The housing cap is surmounted by a retention ring. This retention ring is held in place by a compression snap ring that is insertable into a snap ring compression groove machined into the internal surface of the ball joint housing.

### BRIEF DESCRIPTION OF THE DRAWINGS

FIG. 1 is unassembled expanded view of the ball joint 2.

FIG. 2 is an assembled side view of the ball joint 2.

FIG. 3 is a side view of a ball joint 2 secured within a tie rod end 18.

### DETAILED DESCRIPTION OF THE DRAWINGS

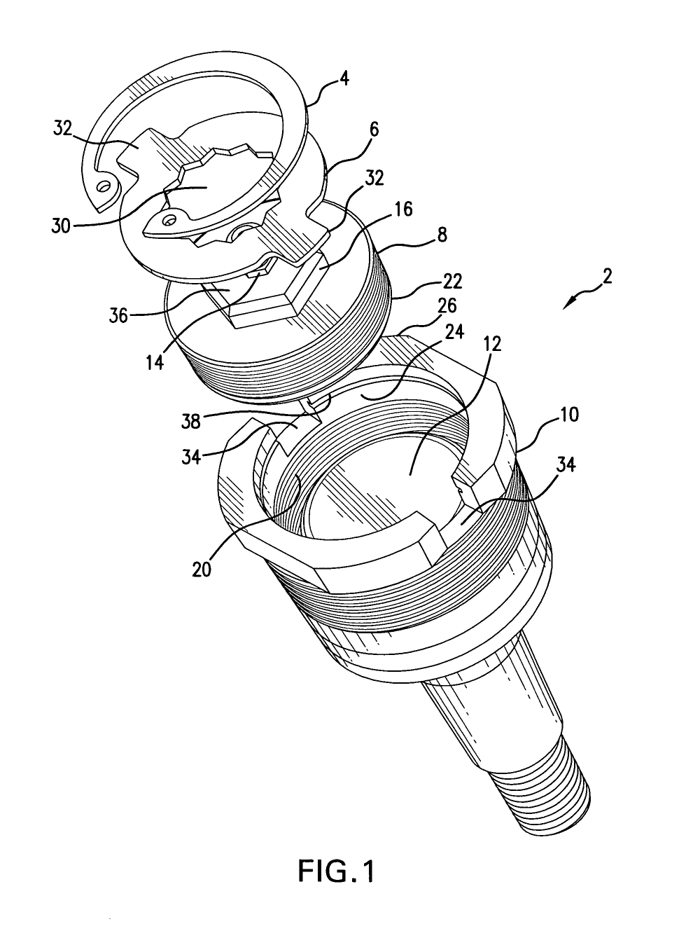

FIG. 1 is unassembled expanded view of the ball joint 2. The ball joint 2 is a novel device that allows easy access. The ball 12 is placed within the ball joint housing 10 and the ball joint housing top 8 is screwed down securing the ball joint 2 within the housing 10. The ball joint housing 10 is threaded 20 on it's inside surface 24. The ball joint housing top 8 is also threaded 22 on its outside surface 26. After the cap 8 is screwed within the housing 10 a retaining plate 6 is placed over the top surface 28 of the top 8. The top 8 has a nut fixture 16 that allows the top 8 to be tightened within the housing 10. The retaining plate 6 has an opening therethrough 30 for the nut cap 16 to pass through. The opening therethrough 30 has a dodecagon shape to lock the ball joint nut cap 16 and therefore top 8 in place. This opening 30 can range from 6 sided hexagons to the dodecagon. The nut cap 16 also has a grease zerk 14 protruding from its top surface 36. The grease zerk 14 is to provide the interior of the housing 10 with lubrication for the ball 12. The retention plate 6 also has two tabs 32 that fit into the groove 34 in the housing 10 to add an extra degree of locking. The housing 10 also contains a groove 38 on its inside surface 24 to facilitate the snap compression ring 4. This ring 4 is to ensure the top 8 remains in place during operation.

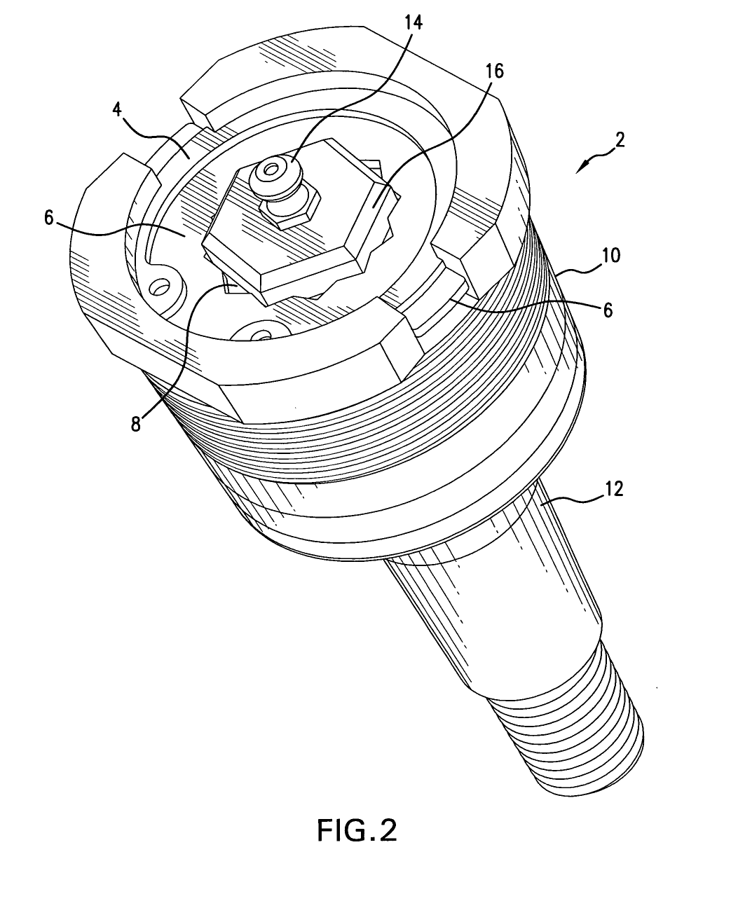

FIG. 2 is an assembled side view of the ball joint 2.The assembled ball joint 2 shows the device in its operational mode. The ball 12 is visible through the bottom of the housing 10. The cap 8 is visible below the retention plate 6. Also visible is the relationship between the snap compression ring 4 and the groove 38 in the housing 10 locking the plate 6in place. Also visible are the nut cap 16 and the grease zerk 14. After the housing cap 8 is threaded into the housing 10 the plate slips over the nut cap 16 and the compression ring 4 snaps into the groove 38 locking everything into place.

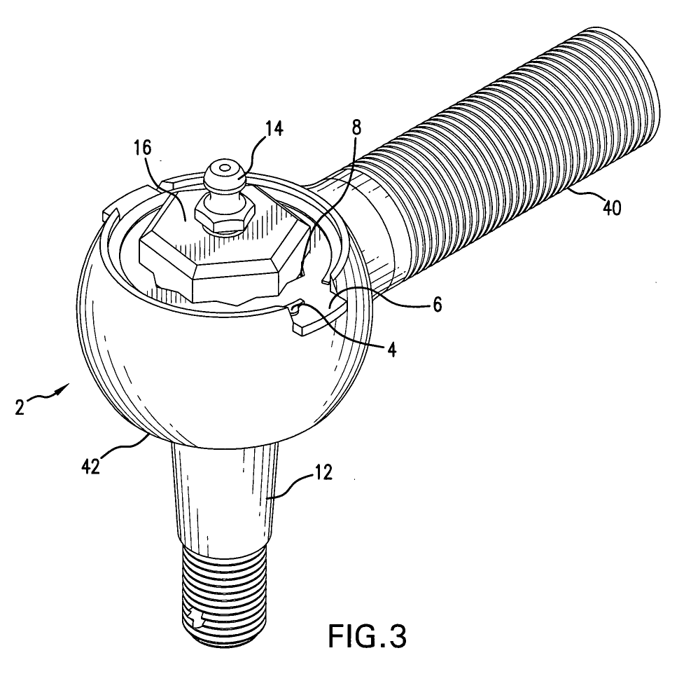

FIG. 3 is a side view of a tie rod end 18 with a ball joint 2 secured within it. The control arm end 40 and the tie rod end 18 acts as housing in this particular embodiment. The same features apply to the control arm 40. Visible are the retention plate 6, the top 8, the nut cap 16, grease zerk 14 and snap compression ring 4.

This novel ball joint 2 has the advantage that the cap 8 can be removed for easy replacement of a ball 12. It also has a grease zerk 14 for easy maintenance. The removal of the cap 8 is also convenient for inspection of the joint or to check the amount of lubrication present within the housing 10. It also has the added feature of the snap compression ring 4 to ensure the integrity of the securing mechanism.

The tie rod end with the ball joint 2 provides flexibility in steering. The majority of the ball joints in existence today are closed units that are press fit together with grease placed within the housing before they are pressed together. The instant invention allows for quick and easy replacement of a ball joint by removal of the top 8. This feature also allows the user the ability to inspect the ball joint or the level of lubrication present within the housing. The removable grease zerk 14 also allows the user to lubricate the ball joint at any time. These properties allow the ball joint 10 to last longer due to the ability to be inspect, greased or repaired in a very limited time frame. The ability to instantly inspect makes the ball joint desirable for racing where every second counts.

Another unique feature of the ball joint 2 is the plate 6. The inside opening 30 is placed over the ball joint nut cap 16 and the retaining plate tabs 32 fit into the grooves 34 of the housing locking the cap 16 into position. This opening 30 in the plate 6 can range from a hexagonal shape to a dodecagonal shape.

What is claimed is:

1. A ball joint comprising in combination:
a ball, said ball having an elongated stem, said ball being movably housed in a ball housing, said housing having an internal surface that is partially threaded;
said ball being surmounted by a housing cap wherein the housing cap has an externally threaded surface, wherein the threads are capable of mating with and joining the threads of the housing;
said housing cap having surmounted thereon, a nut fixture, said nut fixture having a centered opening therein and contained in said opening, a grease zerk;
said housing cap being surmounted by a retention ring, said retention ring being held in place by a compression snap ring that is insertable into a snap ring compression groove machined into the internal surface of the ball joint housing.

2. A ball joint as claimed in claim 1 wherein the ball joint is manufactured from metal.

3. A ball joint as claimed in claim 1 wherein the ball joint is manufactured from ceramic.

4. A ball joint as claimed in claim 1 wherein the ball joint has a fixed grease zerk.

5. A ball joint claimed in claim 1 wherein the ball joint has a removable grease zerk.

6. A ball joint as claimed in claim 1 wherein the ball joint is manufactured in a control arm.

7. A ball joint as claimed in claim 1 wherein the retainer plate opening is a dodecagon.

8. A ball joint claimed in claim 1 wherein the retainer plate opening ranges from a hexagon to a dodecagon.

9. A ball joint as claimed in claim 1 wherein the compression ring is snap ring.

10. A tie rod end that is comprised of a ball joint and a control arm end.
